(19) United States
(12) Patent Application Publication
(10) Pub. No.: US 2023/0239142 A1
(43) Pub. Date: Jul. 27, 2023

(54) METHOD AND APPARATUS FOR ENCODING ORDER INFORMATION

(71) Applicant: ELECTRONICS AND TELECOMMUNICATIONS RESEARCH INSTITUTE, Daejeon (KR)

(72) Inventors: Seung-Kwang LEE, Daejeon (KR); Do-Young CHUNG, Daejeon (KR); Nam-Su JHO, Daejeon (KR)

(21) Appl. No.: 18/155,385

(22) Filed: Jan. 17, 2023

(30) Foreign Application Priority Data
Jan. 24, 2022 (KR) 10-2022-0009854

(51) Int. Cl. H04L 9/08

(52) U.S. Cl. CPC H04L 9/0836

(57) ABSTRACT

Disclosed herein is a method for encoding order information. The method may include generating multiple binary trees, preparing multiple different secret keys, determining a binary tree corresponding to any one secret key selected from among the multiple secret keys, and encoding the order information of the determined binary tree.

### CROSS REFERENCE TO RELATED APPLICATION

This application claims the benefit of Korean Patent Application No. 10-2022-0009854, filed Jan. 24, 2022, which is hereby incorporated by reference in its entirety into this application.

### BACKGROUND OF THE INVENTION

### 1. Technical Field

The present disclosure relates to a method and apparatus for encoding order information for an encrypted database (DB).

### 2. Description of the Related Art

With the advancement of information society, the amount of data processed by individuals and businesses is increased, and resources required for efficiently managing data are also greatly increased. However, it is difficult for all members of information society to bear the expenses required for information management, and more and more information is stored using an external database service.

However, the method of using an external database causes an increase in the number of cases in which sensitive personal information is leaked from such an external database, and it becomes important to present a solution to this problem.

In order to solve the above-mentioned problem, all data is encrypted and stored in a database. Also, an order-preserving encryption technique is used in order to prevent information leakage from an external database.

In a conventional order-preserving encryption technique, after a binary tree is generated, a path from a root node to a node corresponding to a plaintext is encoded as order information, and the order information is stored along with a ciphertext.

Encoded information, including a ciphertext and order information of a plaintext, is used as an index for processing a range search query asked by a client.

However, in the conventional order-preserving encryption technique, because the distribution of a specific plaintext is the same as the distribution of a specific ciphertext, the plaintext may be guessed without decryption.

Also, in the conventional order-preserving encryption technique, there is a correlation between a set of known plaintexts and a set of paths of the plaintexts stored in a DB.

Also, in the conventional order-preserving encryption technique, when a binary tree is expanded by inserting a node, tree rotation is required in order to maintain the tree traversal cost, and whenever tree rotation is performed, an order information encoding table has to be again generated.

Therefore, the conventional order-preserving encryption technique has a problem of degraded encryption performance.

### SUMMARY OF THE INVENTION

An object of the present disclosure is to provide a method and apparatus for encoding order information in order to improve the stability and performance of an encrypted DB.

In order to accomplish the above object, a method for encoding order information according to the present disclosure may include generating multiple binary trees, preparing multiple different secret keys, selecting any one of the multiple secret keys, determining a binary tree corresponding to the selected secret key, and encoding order information of the determined binary tree.

At least one of the multiple binary trees may be formed to have a reverse order to the order of each of remaining binary trees.

The node value of the left subtree of the at least one of the multiple binary trees may be less than the node value of the right subtree thereof, and the node value of the left subtree of each of the remaining binary trees may be greater than the node value of the right subtree thereof.

The ratio between the number of at least one of the multiple binary trees and the number of remaining binary trees may be 1:1.

The root node value of each of the binary trees may be randomly selected. Otherwise, the root node value of each of the binary trees may be a ciphertext of a median value of all plaintexts.

The number of multiple different secret keys may correspond to the number of multiple binary trees.

The order information of the determined binary tree may match the order of plaintexts. Otherwise, the order information of the determined binary tree may be in reverse order to the order of plaintexts.

The method may further include inserting a ciphertext for a plaintext into the determined binary tree.

Also, an apparatus for encoding order information according to an embodiment may include memory in which an order-information-encoding program is stored and a processor for executing the order-information-encoding program. The processor may generate multiple binary trees, prepare multiple different secret keys, select any one of the multiple secret keys, determine a binary tree corresponding to the selected secret key, and encode order information of the determined binary tree.

The processor may generate at least one of the multiple binary trees so as to have a reverse order to the order of each of remaining binary trees.

The processor may perform control such that the node value of the left subtree of the at least one of the multiple binary trees is less than the node value of the right subtree thereof and such that the node value of the left subtree of each of the remaining binary trees is greater than the node value of the right subtree thereof.

The processor may perform control such that the ratio between the number of at least one of the multiple binary trees and the number of remaining binary trees is 1:1.

The processor may perform control such that the root node value of each of the binary trees is randomly selected.

The processor may perform control such that a ciphertext of a median value of all plaintexts is selected as the root node value of each of the binary trees.

The processor may perform control such that the number of multiple different secret keys corresponds to the number of multiple binary trees.

The processor may perform control such that the order information of the determined binary tree matches the order of plaintexts.

The processor may perform control such that the order information of the determined binary tree is in reverse order to the order of plaintexts.

The processor may perform control to insert a ciphertext for a plaintext into the determined binary tree.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an encrypted-data-processing system including an apparatus for encoding order information according to an embodiment of the present disclosure;

FIG. 2 is a block diagram illustrating the configuration of an apparatus for encoding order information according to an embodiment of the present disclosure;

FIG. 3 is a flowchart illustrating a method for encoding order information, performed by an apparatus for encoding order information, according to an embodiment of the present disclosure;

FIG. 4 is a view illustrating the structure of multiple binary tress used in an embodiment of the present disclosure;

FIG. 5 is a view illustrating a change in a correlation for a plaintext according to an embodiment of the present disclosure; and

FIG. 6 is a block diagram illustrating the configuration of a computer system according to an embodiment of the present disclosure.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

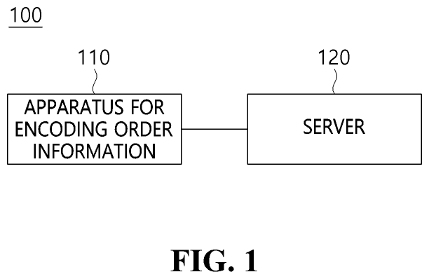

FIG. 1 is a block diagram illustrating an encrypted-data-processing system 100 including an apparatus for encoding order information according to an embodiment of the present disclosure.

Referring to FIG. 1, the encrypted-data-processing system 100 according to an embodiment may include an apparatus 110 for encoding order information and a server 120.

The apparatus 110 for encoding order information according to an embodiment may generate encrypted data by encrypting original data, and may generate an index for retrieving the encrypted data.

Specifically, the apparatus 110 for encoding order information may generate multiple binary trees and generate a ciphertext to be inserted in each of the generated binary trees. The apparatus 110 for encoding order information may encode order information of the multiple binary trees and insert a ciphertext into the binary trees based on the encoded order information. The apparatus 110 for encoding order information may generate encoded information, including the ciphertext and the order information, as an index and transmit the same to the server.

The server 120 may retrieve encrypted data, corresponding to a keyword used for deriving additional information, using a stored index. The server 120 may include memory, a processor, and a communication unit, but the configuration thereof is not limited thereto.

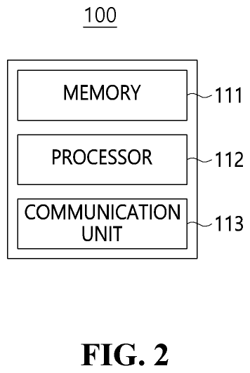

FIG. 2 is a block diagram illustrating the configuration of an apparatus for encoding order information according to an embodiment of the present disclosure.

Referring to FIG. 2, the apparatus 110 for encoding order information according to an embodiment may include memory 111, a processor 112, and a communication unit 113.

The memory 111 may store various kinds of data for overall operation, such as a control program, and the like, for encoding order information. Specifically, the memory 111 may store multiple applications running in the apparatus 110 for encoding order information and data and instructions for operation of the apparatus 110 for encoding order information.

Also, the memory 111 may store various kinds of data, such as plaintexts, ciphertexts, binary tree information, indexes, and the like, which is information required in the apparatus 110 for encoding order information, but the kinds of data stored in the memory 111 are not limited thereto.

The memory 111 may include magnetic storage media or flash storage media, but the types of media are not limited thereto.

The communication unit 113 may transmit and receive data to and from the server 120 over a network. The communication unit 113 may be a device including hardware and software required for transmitting and receiving signals, such as control signals and data signals, through wired/wireless connection with other network devices.

The communication unit 113 may perform communication using a Low-Power Wireless Network (LPWN) and a Low-Power Wide Area Network (LPWAN), such as Narrowband Internet-of-Things (NB-IoT), LoRa, SigFox, and LTE Cat 1, as well as 3G, LTE, and 5G.

The communication unit 113 may perform communication using a communication method using a wireless LAN, such as Wi-Fi 802.11 a/b/g/n, as well as a Local Area Network (LAN). Also, the communication unit 113 may perform communication with an external device using a communication method such as NFC or Bluetooth.

The processor 112 is a kind of central processing unit, and may control the overall operation of the apparatus 110 for encoding order information.

The processor 112 may include all kinds of devices capable of processing data. Here, the ‘processor’ may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but are not limited thereto.

Hereinafter, a method for encoding order information, performed by the processor 112 of the apparatus 110 for encoding order information, will be described in detail.

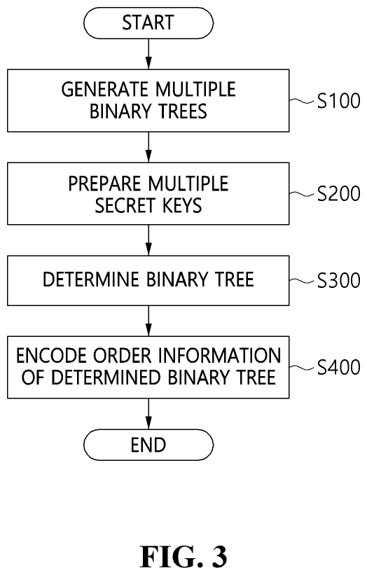

FIG. 3 is a flowchart illustrating a method for encoding order information, performed by an apparatus for encoding order information, according to an embodiment of the present disclosure.

Referring to FIG. 3, the apparatus 110 for encoding order information may generate multiple binary trees at step S100. Two or more binary trees may be formed, and the number thereof is not limited.

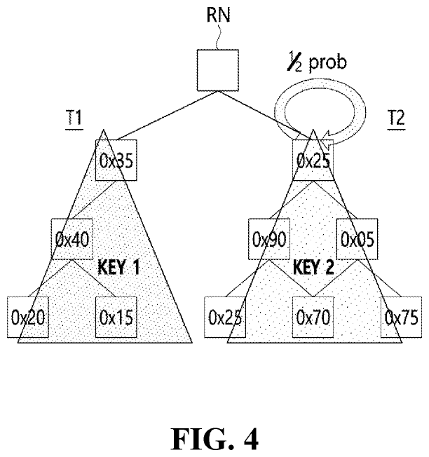

FIG. 4 is a view illustrating the structure of multiple binary tress used in an embodiment of the present disclosure.

As illustrated in FIG. 4, the apparatus 110 for encoding order information may generate a binary tree having a structure that includes a root node RN, a first binary tree T1, and a second binary tree T2.

The node value of the root node RN may be randomly selected. Otherwise, the node value of the root node RN may be a ciphertext of the median value of all plaintexts.

The first binary tree T1 and the second binary tree T2 may be connected to the single root node RN. The first binary tree T1 and the second binary tree T2 may be formed such that one of the binary trees is in reverse order to the order of the other one.

For example, the first binary tree T1 may be formed such that the node value of the left subtree thereof is less than the node value of the right subtree thereof. Conversely, the second binary tree T2 may be formed such that the node value of the left subtree thereof is greater than the node value of the right subtree thereof.

Otherwise, the first binary tree T1 may be formed such that the node value of the left subtree thereof is greater than the node value of the right subtree thereof. Conversely, the second binary tree T2 may be formed such that the node value of the left subtree thereof is less than the node value of the right subtree thereof.

The value that is first inserted into each of the binary trees may be inserted into the root node thereof. Alternatively, an arbitrary value may be inserted into the root node.

Here, the configuration of order-information encoding may be different from that in the conventional method. When m binary trees are used, the first log m bits are used as the index for selecting a binary tree. After that, the path from the root node RN to a corresponding node in the binary tree is added, and for the remaining bits, zero-padding is applied after ‘1’.

For example, when a total of eight bits is used for encoding and when only one bit is used for the index of a binary tree, the location of ‘0x40’ may be 00100000.

Referring back to FIG. 3, the apparatus 110 for encoding order information may prepare m different secret keys to be used for a given encryption algorithm in order to generate a ciphertext to be inserted into each binary tree at step S200. The number of different secret keys may be determined depending on the number of binary trees. Here, the encryption algorithm may indicate a symmetric key cryptography algorithm having a secret key k, and this is known technology, thus a detailed description thereof will be omitted.

For example, the first binary tree T1 may manage ciphertexts encrypted with a first secret key Key1, as illustrated in FIG. 4. The second binary tree T2 may manage ciphertexts encrypted with a second secret key Key2.

The apparatus 110 for encoding order information may evenly select the secret keys in order to encrypt plaintexts. By selecting a secret key, the binary tree based on which order information encoding is to be calculated may be selected at step S300.

As illustrated in FIG. 4, the encoded value of the order information of the first binary tree T1 may match the order of plaintexts, and the encoded value of the order information of the second binary tree T2 may be in reverse order to the order of the plaintexts.

As described above, the apparatus 110 for encoding order information may perform encoding on the order information of the selected binary tree at step S400.

Specifically, the apparatus 110 for encoding order information may randomly select one of the multiple sub-binary-trees in order to acquire the encoded value of the order information of the plaintext.

The apparatus 110 for encoding order information may retrieve the location at which a ciphertext for a given plaintext is to be inserted by branching from the root node one by one.

The client may receive the value of the root node of the selected subtree, decrypt the same with the secret key mapped to the corresponding tree, and compare the size thereof with that of the plaintext.

When the location at which the ciphertext is inserted is found by branching to the left or right child node based on the values of the left and right child nodes in the corresponding binary tree, the path value calculated from the root node becomes the encoded value of the order information.

Meanwhile, when plaintexts are not evenly distributed, the number of rotations for maintaining the balance of a binary tree may be reduced, compared to the conventional method that uses only a single binary tree. This alleviates a problem in which the order information encoding table connected to each tree has to be again generated whenever the binary tree is rotated, thereby having a considerable effect of reducing DB update costs.

The apparatus 110 for encoding order information may insert the ciphertext for the plaintext into the selected binary tree.

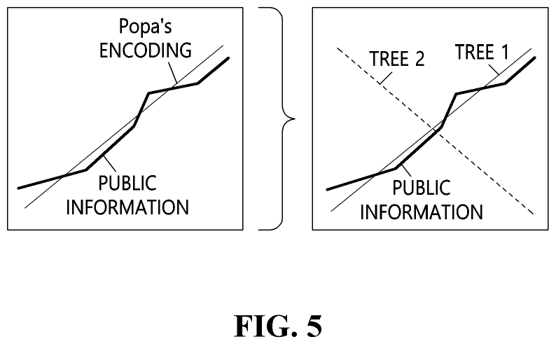

FIG. 5 is a view illustrating a change in a correlation for a plaintext according to an embodiment of the present disclosure.

As illustrated in FIG. 5, it can be seen that, when a single binary tree is used, there is a correlation between a set of encoded order information and a set of plaintexts.

In contrast, when two binary trees are used, a specific plaintext set is not able to be identified from a ciphertext set because there is no correlation between a set of encoded order information and a set of plaintexts, whereby encryption stability may be improved.

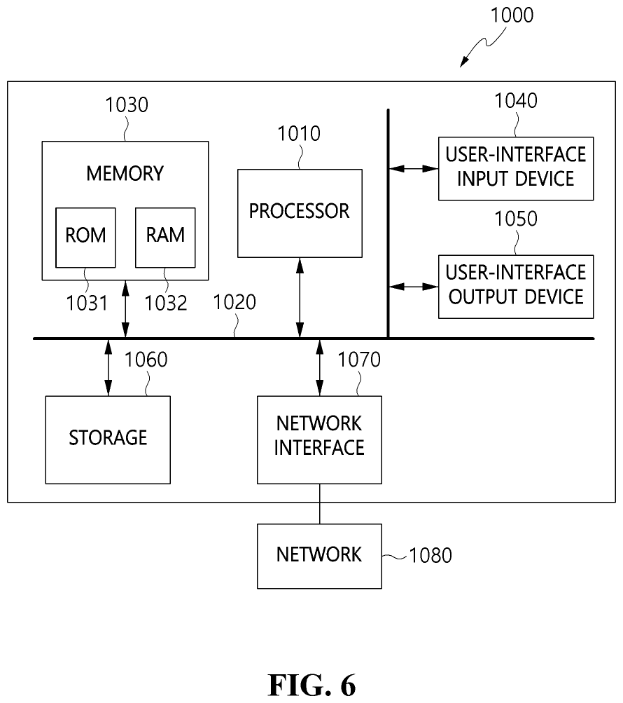

FIG. 6 is a block diagram illustrating the configuration of a computer system according to an embodiment of the present disclosure.

The apparatus 110 for encoding order information according to an embodiment may be implemented in a computer system 1000 including a computer-readable recording medium.

Referring to FIG. 6, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the computer-readable recording medium storing a computer program therein may contain instructions for making a processor perform a method including an operation for generating multiple binary trees, an operation for preparing multiple different secret keys, an operation for selecting a binary tree by selecting any one of the multiple secret keys, and an operation for encoding the order information of the selected binary tree.

According to an embodiment, a computer program stored in the computer-readable recording medium may include instructions for making a processor perform a method including an operation for generating multiple binary trees, an operation for preparing multiple different secret keys, an operation for selecting a binary tree by selecting any one of the multiple secret keys, and an operation for encoding the order information of the selected binary tree.

The present disclosure may effectively distribute ciphertexts by using multiple binary trees.

Also, the present disclosure uses multiple binary trees, which reduces the number of rotations of the trees, whereby DB performance may be improved.

Also, the present disclosure uses a binary tree having the reverse order to the order of another binary tree, thereby removing the correlation between the encoded value of order information and a plaintext.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for encoding order information, comprising:
generating multiple binary trees;
preparing multiple different secret keys;
selecting any one of the multiple secret keys and determining a binary tree corresponding to the selected secret key; and
encoding order information of the determined binary tree.

2. The method of claim 1, wherein at least one of the multiple binary trees is formed to have a reverse order to an order of each of remaining binary trees.

3. The method of claim 2, wherein:
a node value of a left subtree of the at least one of the multiple binary trees is less than a node value of a right subtree thereof, and
a node value of a left subtree of each of the remaining binary trees is greater than a node value of a right subtree thereof.

4. The method of claim 2, wherein a ratio between a number of at least one of the multiple binary trees and a number of remaining binary trees is 1:1.

5. The method of claim 1, wherein a root node value of each of the binary trees is randomly selected.

6. The method of claim 1, wherein a root node value of each of the binary trees is a ciphertext of a median value of all plaintexts.

7. The method of claim 1, wherein a number of multiple different secret keys corresponds to a number of multiple binary trees.

8. The method of claim 1, wherein the order information of the determined binary tree matches an order of plaintexts.

9. The method of claim 1, wherein the order information of the determined binary tree is in reverse order to an order of plaintexts.

10. The method of claim 1, further comprising:
inserting a ciphertext for a plaintext into the determined binary tree.

11. An apparatus for encoding order information, comprising:
memory in which an order-information-encoding program is stored; and
a processor for executing the order-information-encoding program,
wherein the processor generates multiple binary trees, prepares multiple different secret keys, selects any one of the multiple secret keys, determines a binary tree corresponding to the selected secret key, and encodes order information of the determined binary tree.

12. The apparatus of claim 11, wherein the processor generates at least one of the multiple binary trees so as to have a reverse order to an order of each of remaining binary trees.

13. The apparatus of claim 12, wherein the processor performs control such that a node value of a left subtree of the at least one of the multiple binary trees is less than a node value of a right subtree thereof and such that a node value of a left subtree of each of the remaining binary trees is greater than a node value of a right subtree thereof.

14. The apparatus of claim 12, wherein the processor performs control such that a ratio between a number of at least one of the multiple binary trees and a number of remaining binary trees is 1:1.

15. The apparatus of claim 11, wherein the processor performs control such that a root node value of each of the binary trees is randomly selected.

16. The apparatus of claim 11, wherein the processor performs control such that a ciphertext of a median value of all plaintexts is selected as a root node value of each of the binary trees.

17. The apparatus of claim 11, wherein the processor performs control such that a number of multiple different secret keys corresponds to a number of multiple binary trees.

18. The apparatus of claim 11, wherein the processor performs control such that the order information of the determined binary tree matches an order of plaintexts.

19. The apparatus of claim 11, wherein the processor performs control such that the order information of the determined binary tree is in reverse order to an order of plaintexts.

20. The apparatus of claim 11, wherein the processor performs control to insert a ciphertext for a plaintext into the determined binary tree.
